(19) United States
(12) Patent Application Publication
(10) Pub. No.: US 2009/0038584 A1
(43) Pub. Date: Feb. 12, 2009

(54) Internal combustion engine

(76) Inventors: Wolfram Schmid, Nuertingen (DE); Stephan Kraetschmer, Schwabisch Gmund (DE); Siegfried Sumser, Stuttgart (DE)

Correspondence Address: KLAUS J. BACH & ASSOCIATES, 4407 TWIN OAKS DRIVE, MURRYSVILLE, PA, 15668, US

(21) Appl. No.: 12/221,790

(22) Filed: Aug. 6, 2008

Related U.S. Application Data
(63) Continuation-in-part of application No. PCT/EP2007/000722, filed on Jan. 27, 2007.

(30) Foreign Application Priority Data
Feb. 7, 2006 (DE) 10 2006 005 336.2

(51) Int. Cl. F02D 13/04

(52) U.S. Cl. 123/321

(57) ABSTRACT

In an internal combustion engine which is alternatively operated in a powered four-stroke engine driving mode and in a two-stroke engine braking mode with an inlet and an outlet valve stroke curve control device which is provided for adjusting the stroke of both the inlet and of the outlet valves, the valve stroke curve control device holds the outlet valve continuously open in the engine braking mode.

This is a Continuous-In-Part Application of pending International patent application PCT/EP2007/000722 filed Jan. 27, 2007 and claiming the priority of German patent application 10 2006 005 336.2 filed Feb. 7, 2006.

### BACKGROUND OF THE INVENTION

The invention relates to an internal combustion engine for operation alternatively in a spark-ignited four-stroke driving mode and in two-stroke engine braking mode, in which the valves are so controlled that air is compressed in the cylinders and then discharged into the exhaust tract.

A two-stroke engine braking method is described in DE 10 2004 006 681 A1, according to which, in the engine braking mode during the expansion phase of the cylinders, the inlet valve is opened just before the piston reaches the bottom dead center position, so that air can flow into the cylinder via the intake section, and the inlet valve is closed again after the bottom dead center is passed. In a subsequent compression phase, the outlet valve is opened just before the top dead center position is reached, so that the compressed combustion air flows out of the cylinder into the exhaust tract via the open outlet valve. Just after the top dead center has been passed, the outlet valve is closed again and the cycle starts anew.

The internal combustion engine described in DE 10 2004 006 681 A1 is provided with an exhaust gas turbo-charger which comprises a compressor in the intake section and an exhaust gas turbine in the exhaust train. The exhaust gas turbine is equipped with a variable turbine geometry which permits variable setting of the effective turbine inlet cross-section. In a back pressure position which reduces the open passage area in the turbine, an increased exhaust gas back pressure is produced in the line section between the cylinder outlets and the exhaust gas turbine, as a result of which the pistons in the cylinders have to perform increased expulsion work. As a result, the engine braking power can be considerably increased.

It is the object of the present invention to provide an internal combustion engine in which high braking power levels can be implemented with low structural complexity.

### SUMMARY OF THE INVENTION

In an internal combustion engine which is alternatively operated in a powered four-stroke engine driving mode and in a two-stroke engine braking mode with an inlet and an outlet valve stroke curve control device which is provided for adjusting the stroke of both the inlet and of the outlet valves, the valve stroke curve control device holds the outlet valve continuously open in the engine braking mode.

In an advantageous embodiment, the stroke curve adjustment of both the inlet valve and of the outlet valve providing for a change over between the four-stroke driving mode and the two-stroke engine braking mode are performed in a common actuating movement. According to an alternative embodiment, it is however, also possible to provide, in the stroke curve adjustment device, separate actuating units which act respectively on the inlet valve and the outlet valves.

Furthermore, by means of a corresponding action using the stroke curve adjustment device, the outlet valve can be controlled in such a way that it is continuously open during the entire engine braking mode, that is to say both in the expansion phase as well as in the compression phase. In the two-stroke engine braking mode, during the expansion phase of the cylinders, the inlet valve is opened before the bottom dead center is reached, with the result that the combustion air can flow from the intake passage into the combustion chamber of the cylinders. After the bottom dead center has been passed, the inlet valve is closed and in the subsequent stroke of the piston, the content of the combustion chamber is compressed. With increasing compression, the combustion air is expelled from the combustion chamber into the exhaust train via the continuously open outlet valve. In this way, the actuating expenditure is considerably reduced. It is particularly advantageous that no actuating movement of the outlet valve has to be carried out counter to the very high cylinder internal pressures, as a result of which compared to embodiments from the prior art, a considerable saving in energy is achieved. Furthermore, the actuating unit in the stroke curve adjustment device can be correspondingly smaller.

The internal combustion engine is basically used without an additional brake valve. The expulsion is carried out exclusively via the opened outlet valve, which in the two-stroke engine braking mode additionally carries out the function of a brake valve. Since the movement of the outlet valve is minimized, small actuating forces are sufficient to act on the outlet valve at the transition from the spark-ignited driving mode to the engine braking mode, and vice versa. During the engine braking mode no actuating forces, or only small actuating forces, are required to move the outlet valve. The movement of the inlet valve is also possible with only very small actuating forces since the opening of the inlet valve occurs just before the bottom dead center in a phase with low combustion chamber pressure.

In a first advantageous embodiment the stroke curve of the outlet valve remains completely constant during the engine braking operating mode, that is, the outlet valve is held in a constant open position without any change to the stroke curve. In this variant, no actuation forces are necessary for the outlet valve during the engine braking mode.

Although, in a second advantageous variant, the outlet valve is held in an open position during the entire engine braking mode, the stroke curve varies between a position of minimum opening and a position of maximum opening. In order to minimize the expenditure involved in actuation, the change in the stroke of the outlet valve is advantageously within tight limits. The advantage of this embodiment is that, during the expansion phase with the inlet valve opened, a greater charge of the combustion chamber is possible, and during the compression phase a relatively high internal pressure can be established in the combustion chamber.

By means of the stroke curve adjustment device it is expediently possible to set a continuous transition in the stroke curves of the inlet valve and of the outlet valve during the changeover from the four-stroke driving mode to the two-stroke engine braking mode and vice versa. On the one hand, the steady transmission avoids jumps in the stroke curves and on the other hand the transition regions in the stroke curve adjustment device constitute additional possibilities for settings for influencing the stroke curves.

According to one expedient embodiment, the stroke curve adjustment device comprises an adjustable camshaft which acts on the valves. It has, for each valve, a cam for providing the cam curve of the driving mode and a cam for operating the valve during the engine braking mode. The cam for each valve accordingly has two sections which are respectively assigned to the driven operating mode and to the braking mode. The sections expediently have a continuous transition. Furthermore, it may be advantageous to arrange the cams for the inlet valves and the cams for the outlet valves on a common camshaft so that the transition between the driving mode and the engine braking mode can be performed with just one actuating movement of the camshaft. A camshaft can be moved a short distance in axial direction for this purpose.

According to an alternative embodiment, the cams for the inlet valves and the cams for the outlet valves can also be arranged on different camshafts. In this configuration it is also possible for both cams to be acted on by a common actuator element which axially adjusts the camshafts for the transition between the driven operating mode and engine braking mode.

Influencing the valve stroke curves by means of a camshaft constitutes an advantageous mechanical embodiment. However, alternatively it is also possible to use further stroke curve adjustment devices, for example, hydraulic or electromagnetic actuating devices.

According to a further advantageous embodiment, the internal combustion engine is provided with an exhaust gas turbocharger which comprises a compressor in the intake section and an exhaust gas turbine in the exhaust train. The exhaust gas turbine can be provided with a variable turbine geometry for variably setting the effective turbine inlet cross-section. Herein the turbine inlet flow cross-section is adjustable between an open position of maximum opening and a reduced flow cross-section blocking state. In order to increase the engine braking power, the turbine geometry is moved into the blocking position, as a result of which an increased exhaust gas back pressure is generated in the exhaust train between the cylinder outlet and the exhaust gas turbine, which back pressure counteracts the expulsion work of the pistons into the cylinders. The positioning of the variable turbine geometry constitutes an additional influencing variable for adjusting the engine braking power.

Furthermore, a bypass which bypasses the exhaust gas turbine and into which an adjustable bypass valve is integrated may be provided. When the bypass valve is opened, the exhaust gas back pressure is reduced by bypassing the exhaust gas turbine. The setting of the bypass valve constitutes a further degree of freedom for the adjustment of the engine braking power, and furthermore, provides for an overload protection in the exhaust gas turbine.

The invention will become more readily apparent form the following description thereof on the basis of the accompanying drawings:

### BRIEF DESCRIPTION OF THE DRAWINGS

FIG. 1 is a schematic illustration of an internal combustion engine with an exhaust gas turbocharger showing one of the cylinders of the internal combustion engine in an enlarged view including the assigned inlet and outlet valves and a camshaft which influences the stroke curve of the valves,

FIG. 2 is a phase diagram showing the inlet-open and inlet-closed times for the inlet valve during the execution of the two-stroke engine braking method including a schematic illustration of the profile of the stroke curve of the outlet valve, and

FIG. 3 is a diagram comprising the stroke curves of the inlet and outlet valves as a function of the crank angle, each illustrated for the spark-ignited driving mode (dashed line) and two-stroke engine braking mode (continuous line).

### DESCRIPTION OF PARTICULAR EMBODIMENTS

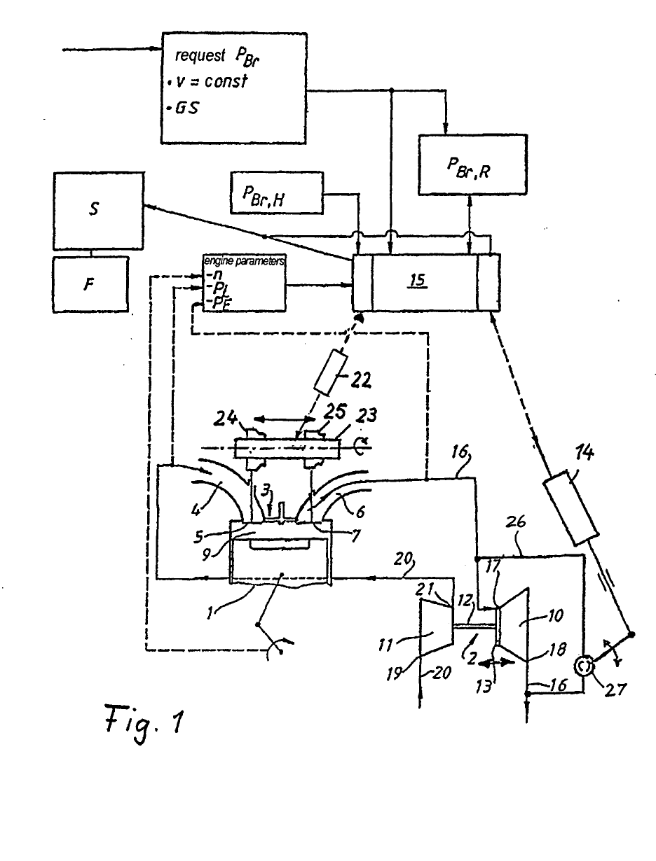

One of the cylinders 1 of the internal combustion engine, for example, a diesel engine or a spark-ignition engine, is illustrated schematically in FIG. 1. The cylinder 1 includes a combustion chamber 9 which is connected to the inlet duct 4 via an inlet valve 5, and to the exhaust manifold 6 via an outlet valve 7. The inlet valve 4 is a component of the intake section 20 of the internal combustion engine, and the exhaust manifold 6 is connected to the exhaust line 16. When the inlet valve 5 is opened, combustion air is introduced into the combustion chamber of the cylinder 1 via the inlet duct 4 and when the outlet valve 7 is opened, the residual gas located in the combustion chamber is carried away via the exhaust manifold 6. The control of the valves 5 and 7 is carried out by means of a camshaft 23 on which cams 24 and 25 are arranged. The cam 24 is assigned to the inlet valve 5 and the cam 25 is assigned to the outlet valve 7. The motion caused by the cam contour is transmitted to the valves 5, 7 by means of suitable transmission elements, and it determines the stroke curve of the valves. During their rotation around the camshaft longitudinal axis, the contour of each cam is sensed and transmitted.

In order to be able to implement different stroke curves for the inlet valve 5 and for the outlet valve 7 for the spark-ignition driving mode and the engine braking mode each of the cams 24 and 25 is constructed in two parts, wherein one cam section of each cam 24 and 25 of the spark-ignited driving mode and the adjacent cam section on each cam is assigned to the engine braking mode. The cam sections are located axially directly adjacent to one another and are connected to one another over a steady transition area. The changeover between the adjacent cam sections is carried out by means of an axial adjustment of the camshaft 23 which is brought about by means of an actuator 22.

The internal combustion engine 1 is also provided with an exhaust gas turbocharger 2 which comprises an exhaust gas turbine 3 in the exhaust line 16, and a compressor 11 in the intake section 20. The turbine wheel in the exhaust gas turbine 10 and the compressor wheel in the compressor 11 are coupled in a rotationally fixed fashion by means of a shaft 12. While the internal combustion engine is operating, combustion air from the surroundings enters the compressor 11 via the compressor inlet 19, where it is compressed to a raised pressure by the compressor wheel. This compressed air exits the compressor 11 via the compressor outlet 21 and is fed via the intake section line 20 into the inlet duct 4, possibly after flowing through a charge air cooler. On the exhaust side, the gas, which has been discharged from the combustion chamber 9, flows via the exhaust line 16 and the turbine inlet 17 into the exhaust gas turbine 10 in which the turbine wheel is driven thereby. The expanded gas is carried out of the turbine via the turbine outlet 18.

The exhaust gas turbine 10 is equipped with a variable turbine geometry 13 via which the effective turbine inlet cross-section can be adjusted with respect to the turbine wheel between a minimum blocking position and a position of maximum opening. The variable turbine geometry is advantageously embodied as a braking vane structure, which can be moved axially into the turbine inlet duct. Alternatively, the use of a guide vane structure with adjustable guide vanes is also possible. Further possible structural embodiments are asymmetrical turbines with relatively small and relatively large exhaust gas flows for two-flow impinging on the turbine wheel, with the supply of gas in each exhaust gas flow being separate and controllable and the turbine inlet cross-section of at least one of the two exhaust gas flows into the turbine wheel being adjustable by means of variable turbine geometry.

In order to adapt the size of the turbine in an optimum way to the internal combustion engine to be used and to permit high engine braking power values with relatively low thermal stresses, a turbo-braking factor TBF is defined, in order to dimension the exhaust has turbo-charger, said turbo-braking factor TBF being determined according to the relationship

TBF=A_{T,h}*D_{T}/V_{H}

from the free-flow cross-section A_{T,h} in the exhaust path to the turbine at maximum braking power, the inlet diameter D_{T} of the turbine wheel and the displacement volume V_{H} of the internal combustion engine. For small exhaust gas turbochargers, for example exhaust gas turbochargers in passenger cars, the turbo-braking factor TBF has a value of less than 0.002 (2 ⁰/00), and this value can, if appropriate, also be lower than 0.5 ⁰/00. For relatively large engines, in particular for heavy trucks, the turbo-braking factor may be less than 0.0075 (7.5 ⁰/00), preferably less than 0.005 (5 ⁰/00).

The exhaust gas turbine 10 is bypassed by a bypass 26 which branches off from the exhaust line 16 upstream of the exhaust gas turbine 10 and opens into the exhaust line again downstream of the exhaust gas turbine. In the bypass 26 there is an adjustable bypass valve 27 which can be adjusted infinitely between a blocking position and an open position by means of an actuator 14.

The actuator elements and actuators in the internal combustion engine and the assemblies assigned to the internal combustion engine are controlled using actuation signals of a closed-loop and open-loop control unit 15 as a function of various state variables and operating variables. The state variables and operating variables comprise as the engine parameters, inter alia, the engine speed n, the charge pressure p_{L} in the inlet duct 4 and the turbine inlet pressure p_{E} at the turbine inlet 17. Further influencing variables are the braking power demand P_{Br} which is generated by the driver and which is fed to the mechanical wheel brake P_{Br,R} and if appropriate, the handbrake P_{Br,H}. The velocity v and, if appropriate, a hazard signal GS which designates a hazard situation are variables which characterize the operating state and which are processed in the closed-loop and open-loop control unit 15. Furthermore, in a block S, a safety check can be carried out on the charge-exchange valves, and in the case of a fault, a fault signal F is displayed.

The spark-ignition driving mode is carried out in the four-stroke cycle, while the engine braking mode is carried out in the two-stroke cycle. In the engine braking mode, a inlet valve 5 is opened in the expansion phase of the cylinder 1 before the bottom dead center is reached, after which the combustion air from the intake section 20 can flow into the combustion chamber 9 via the inlet duct 4. After the bottom dead center has been passed, the inlet valve 5 is closed again, the combustion air is compressed in the immediately following compression phase and discharged into the exhaust line 16 via the outlet valve 7 in the open position, and via the exhaust manifold 6.

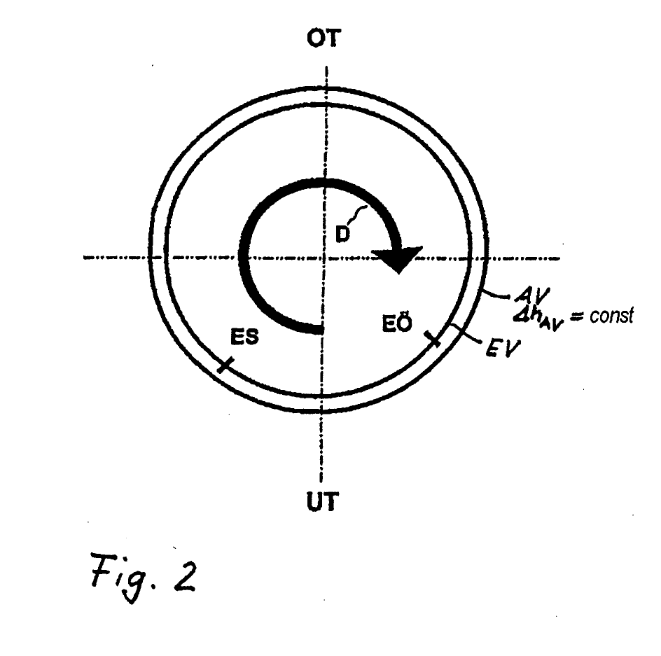

In the phase diagram according to FIG. 2, the stroke curves for the inlet valve 5 and the outlet valve 7 are illustrated over a crank angle range of 360°. The stroke curve of the inlet valve is denoted by EV and the stroke curve of the outlet valve by AV. The direction D of the arrow characterizes the reversal direction. The phase diagram represents the two-stroke engine braking mode according to which the inlet valve is opened during the expansion cycle of the piston just before the bottom dead center UT is reached at the inlet opening time EÖ. Because the combustion chamber pressure which is low in this phase, the inlet valve can be opened without counterpressure, and furthermore, the combustion air which is under charge pressure flows into the combustion chamber. After the bottom dead center UT has been passed, the inlet valve is closed again at the inlet closing time ES. The times EÖ and ES are, for example, in a crank angle range of 30° before and respectively after the bottom dead center UT.

The crank angle range between the top dead center OT and bottom dead center UT characterizes the expansion cycle, and the adjoining crank angle range between the bottom dead center UT and top dead center OT constitutes the compression cycle. After the inlet valve has been closed, the gases in the combustion chamber are compressed in the compression cycle. The flowing out occurs via the opened outlet valve which is expediently in a constant open position with a stroke Δh_{AV}=constant during the entire engine braking mode, that is to say during the compression cycle and during the expansion cycle. Since the position of the outlet valve does not change during the entire engine braking mode, there is also no need for expenditure involving actuation for the operation of the outlet valve. Compared to embodiments in which the outlet valve has to open counter to the high combustion chamber internal pressure just before the top dead center OT is reached, this constitutes a simplification and a saving in energy. The pressure losses arising due to the opened outlet valve during the expansion cycle and the compression cycle can be kept within acceptable limits as a result of a small opening stroke of the outlet valve.

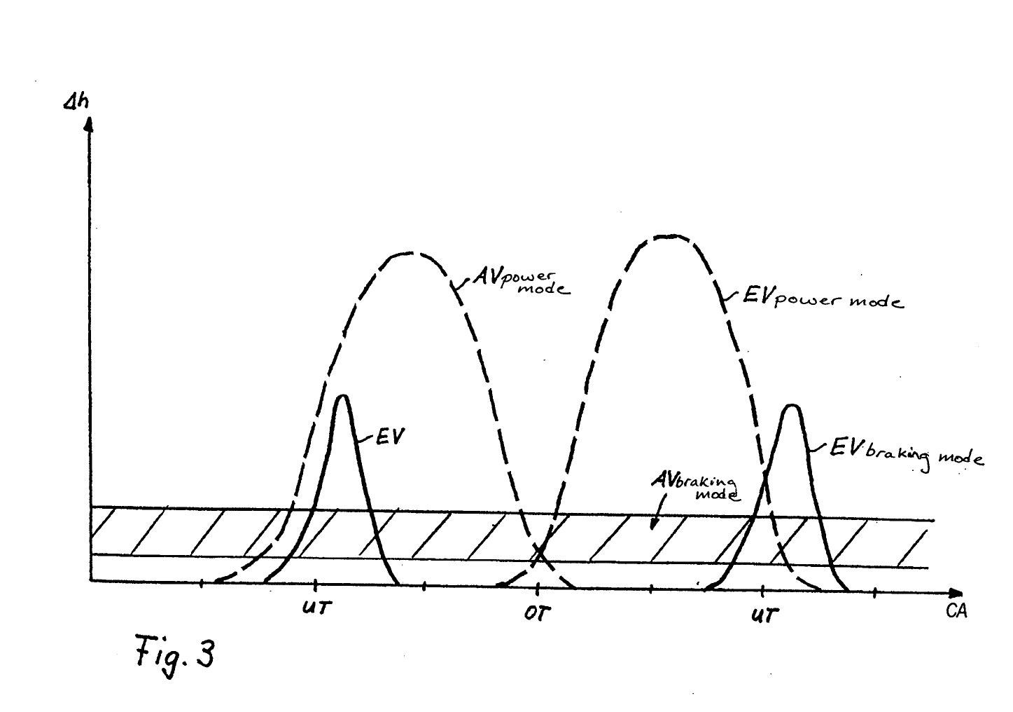

In the diagram according to FIG. 3, the valve-lifting curves Δh are plotted as a function of the crank angle CA. The lifting curves EV for the inlet valve and AV for the outlet valve are illustrated, each plotted for the spark-ignition driving mode in the four-stroke cycle (dashed line) and for the two-stroke engine braking mode (continuous line EV for the inlet valve EV and stroke band AV delimited by spaced continuous lines for the outlet valve).

In the four-stroke driving mode, the outlet valve is opened just before the bottom dead center UT and the open position is maintained approximately up to the time when the top dead center is reached. The inlet valve is opened with a small degree of overlap with the outlet valve in the region of the top dead center, with the opening phase lasting up to the subsequent bottom dead center UT.

In the two-stroke engine braking mode, which is represented by a continuous dashed line in FIG. 3, the outlet valve is continuously in the opened state according to the lifting curve AV. A band range for the lifting curve AV of the outlet valve is plotted in FIG. 3, with the open position of the outlet valve expediently varying within this plotted bandwidth. It is possible either to keep the outlet valve at a constant, invariable value during the entire engine braking operation or to vary the lifting curve of the outlet valve within the illustrated bandwidth, which varies at a low opening level.

According to the plotted stroke curve EV, the inlet valve is opened just before the bottom dead center is reached and is closed again just after the bottom dead center UT is passed. The maximum opening stroke of the inlet valve stroke curve is considerably below the maximum stroke of the inlet valve in the spark-ignition driving mode. The same applies to the outlet valve which has an even lower opening stroke in the engine braking mode than the inlet valve.

What is claimed is:

1. An internal combustion engine with cylinders having inlet and outlet valves (3, 7) for controlled communication with inlet and outlet passages for operating the engine alternatively in a spark-ignited four-stroke driving mode and in a two-stroke engine braking mode, wherein combustion air is fed to the cylinders (1), to be compressed in the cylinders (1) and subsequently expelled into an exhaust duct (16), whereby, in the expansion phase of the cylinders (1) the inlet valves (5) are opened before the bottom dead center (UT) is reached and are closed again after the bottom dead center (UT) has been passed, and the outlet valves (7), which open into the exhaust duct (16) are moved to an open position, said engine including a stroke curve adjustment device (22) for adjusting stroke curves (EV, AV) of both the inlet valves (5) and of the outlet valves (7), with the stroke curve adjustment device (22) acting on the outlet valves (7) at the transition from the spark-ignition driving mode to the engine braking mode in such a way that the outlet valves (7) are continuously open during the entire engine braking mode, both in the expansion phase and in the compression phase.

2. The internal combustion engine as claimed in claim 1, wherein during changeover between the four-stroke driving mode and the two-stroke engine braking mode, the valve-stroke curve control device (22) permits a continuous transition in the stroke curves (EV, AV) of the inlet valves (5) and of the outlet valves (7).

3. The internal combustion engine as claimed in claim 1, wherein the stroke curve control device (22) is connected to an adjustable cam shaft (23) with cams (24, 25) for the inlet valve (5) and the outlet valve (7) with different cam curves for the four-stroke driving mode and for the two-stroke engine braking mode arranged on the cam shaft (23).

4. The internal combustion engine as claimed in claim 3, wherein the cam shaft (23) is axially movable for the control of the valves by the two different types of cams.

5. The internal combustion engine as claimed in claim 1, wherein, with a common actuating movement of the stroke curve control device operated camshaft (23) the stroke curves (EV, AV) of both the inlet valves (5) and of the outlet valves (7) are adjustable between the four-stroke driving mode and the two-stroke engine braking mode.

6. The internal combustion engine as claimed in claim 1, wherein, in the engine braking mode, the outlet valves (7) are held in a constant open position by the stroke curve control device (22).

7. The internal combustion engine as claimed in claim 1, wherein the the camshaft (23) comprises a cylinder structure as a cam for the engine braking mode for keeping the valve in the constant open position.

8. The internal combustion engine as claimed in claim 1, wherein the camshaft (23) for the engine braking mode includes a cone without a cam structure which is axially displaceable for adjustment of the valve stroke.

9. The internal combustion engine as claimed in claim 1, wherein an exhaust gas turbocharger (2) is provided with a compressor (11) in the intake section (20) and an exhaust gas turbine (10) in the exhaust duct (16).

10. The internal combustion engine as claimed in claim 9, wherein the exhaust gas turbine (10) is provided with a variable turbine geometry (13) for variably setting the effective turbine inlet cross-section, wherein, in the engine braking mode, the variable turbine geometry (13) is adjustable into a blocking position which reduces the turbine inlet flow cross-section.

11. The internal combustion engine as claimed in claim 9, wherein a bypass (26) is provided which bypasses the exhaust gas turbine (10) and an adjustable bypass valve (27) is arranged in the bypass (26), so that the requested engine braking power in the engine braking mode can be adjusted by setting the bypass valve (27).

12. The internal combustion engine as claimed in claim 9, wherein the variable turbine geometry (13) is embodied as a braking vane structure which is movable into the turbine inlet duct.

13. The internal combustion engine as claimed in claim 9, wherein the exhaust gas turbocharger (2) is dimensioned in such a way, that a turbine braking factor (TBF) relating to the engine braking mode at maximum braking power of the exhaust gas turbocharger, which is determined according to the relationship
TBF=A_{T}*D_{T}/V_{H}
has a value of less than 0.005 (5 ⁰/00): TBF<0.005, wherein
A_{T}=free flow cross-section in the exhaust gas path to the exhaust gas turbine (10) at maximum braking power
D_{T}=turbine inlet diameter in the exhaust gas turbine
V_{H}=displacement volume of the internal combustion engine.
